(19) United States
(12) Patent Application Publication
(10) Pub. No.: US 2022/0403120 A1
(43) Pub. Date: Dec. 22, 2022

(54) A METHOD FOR PREPARING A PRE-TREATED SYNTHETIC LATEX EMULSION

(71) Applicant: CI TECHNOLOGY SDN BHD, Kuala Lumpur (MY)

(72) Inventor: Kok Ho TEE, Kuala Lumpur (MY)

(73) Assignee: CI TECHNOLOGY SDN BHD, Kuala Lumpur (MY)

(21) Appl. No.: 17/777,707

(22) PCT Filed: Dec. 5, 2019
(86) PCT No.: PCT/MY2019/050105

§ 371 Date: May 18, 2022

(30) Foreign Application Priority Data
Nov. 19, 2019 (MY) PI2019006768

(51) Int. Cl. C08J 3/215

(52) U.S. Cl. CPC C08J 3/215; C08J 2309/04; C08J 2411/02; C08J 2407/02; C08J 2409/10

(57) ABSTRACT

The present invention relates to a method (100) for preparing a pre-treated synthetic latex emulsion, the method comprising the steps of, adding a synthetic latex into a tank (101), characterized by mixing a surfactant with the synthetic latex in the tank (102), adding alkaline material into a mixture of the synthetic latex added with the surfactant (103), adding a reactive metal ion into the mixture (104) and continue mixing the mixture for at least two hours (105), wherein the reactive metal ion is obtained by heating a metal oxide or metal hydroxide with supply of alkaline material at 120 to 180° C.

### TECHNICAL FIELD

The present invention relates to a method for preparing a pre-treated synthetic latex emulsion, more particularly, readily usable in the making of articles by means of casting, extrusion, spraying, painting, coating and dipping.

### BACKGROUND ART

The natural rubber derived from rubber tree, Hevea Brasiliensis is being used in the field of rubber industries producing articles mainly of dipped articles. Over the few decades ago, the pre-vulcanized latex is used in view of reducing process time, improving the end product quality and consistency. Due to allergic issues during in contact with people, less solvent resistance, less shelf life during processing, less strength at low thickness and poor shelf life, the industry is rapidly changing to synthetic latexes. However, one of the synthetic latex i.e. acrylo-nitrile butadiene copolymer is widely being used in the dipping industry at very high level replacing natural rubber.

Since there was a shift in the dipping industry from using natural rubber latex to synthetic latex the usage of natural rubber latex was reduced or growth in the natural rubber article was less in the dipping industry. The factories involved in the manufacturing of dipped articles buy the raw synthetic latex and compound with suitable reactants and other ingredients in line with the intended use and let the latex to mature to enable designed cure level of the final film.

Conventionally, the curing of synthetic latex systems more particularly in nitrile butadiene, styrene, chloroprene and polyisoprene the reaction involves in complex heterogeneous systems involving different solid phases and liquid phases. The complex heterogeneous system requires prolonged reaction time and pre conditioning namely maturation. This is because the addition of reactive chemicals complicates the existing heterogeneous system involving multi sized polymer chains resulting from heterogeneous reaction system influenced by various process parameters including the raw material, initiators, crosslinkers, surfactants and reaction media most aqueous and the temperature and reaction time. For film formation the curatives and other materials used are of solid phase of heterogeneous nature and add up to the existing heterogeneous nature of the polymeric emulsion.

Raw latex for dipping purposes in the industry is supplied by manufacturer mostly in water-based emulsion where the polymeric micro particles which are in solid form are suspended uniformly. The latex is seen as white to the refraction of light even though the solid particle is colourless or translucent it appears white due to the reflection and scattering of light. The supplied raw latex has just sufficient surfactant and electrolyte level to keep the emulsion in stable condition however if the condition changes and affect the pH of solution or energising the particle by UV light or by heat the stability will be endangered. The supplied raw latex is free from ionic bonding agent and covalent bonding agents to avoid destabilisation. If additional bonding agents are added it may lead to the coagulation of rubber particles which in turn affect the intended use of dipping by resulting in uneven film formation and hence the dipped articles result with defects and non-functional.

There have been several solutions provided for efficient method for preparing a pre-treated synthetic latex emulsion, and few of them have been discussed below:

U.S. Pat. No. 6,765,072B1 discloses a process for the preparation of aqueous dispersions of latex particles having a heterogeneous morphology by a semicontinuous emulsion polymerization, comprising the emulsion polymerizing of ethylenically unsaturated (co)monomers, accompanied by, the addition of cationic and/or anionic and/or nonionic emulsifiers and/or protective colloids as stabilizers, which are directly used as such or synthesized in situ, the semicontinuous emulsion polymerization being performed in the presence of the stabilizer or stabilizers with a monomer mixture, which contains at least one nonionic, ethylenically unsaturated monomer with a glass transition temperature Tg above about 30° C. in a quantity of about 10 to 70 wt. %, based on the total weight of ethylenically unsaturated (co)monomers and at least one hydrophilic, ethylenically unsaturated monomer in a quantity of about 5 to 30 wt. %, based on the total weight of ethylenically unsaturated (co)monomers.

U.S. Pat. No. 8,293,817B2 discloses a method for manufacturing natural rubber comprising the steps of adding to a natural rubber latex at least one type of a predetermined sulfonic acid selected from the group consisting of a monoalkyl sulfonic acid, a polyoxyethylene alkyl ether sulfonic acid, and an alkylbenzene sulfonic acid and thereafter, removing moisture from the mixture of the natural rubber latex and the sulfonic acid.

WO2019074354A1 relates to an elastomeric article made from a cured product of synthetic latex composition, characterized by a base polymer; a solubilized polyvalent metal hydroxide having a pH above 9.0 at a range of 0.0001 to 0.20 phr; a milled polyvalent metal oxide; an alkali solution for solubilizing the polyvalent metal hydroxide; and fillers at 0.5 phr minimum for manufacturing the elastomeric article with biodegradable properties; wherein said elastomeric article having thickness of 0.001 to 5 mm; tensile strength of 7 MPa; and elongation of 300% minimum. The invention also relates to the method to manufacture the elastomeric article, comprising preparing a former for shaping the elastomeric article; dipping the former into a coagulant solution; drying the coagulant-coated former; dipping the dried coagulant-coated former into a synthetic latex composition to create the elastomeric article; followed by pre-leaching; vulcanizing; surface treating; post-leaching; applying donning aid; drying and stripping the elastomeric article from the former.

WO 2017116227 A1 disclosed a latex formulation for preparing an accelerator-free nitrile rubber article comprising a mixture of at least one base polymer, a crosslinker, and a pH adjuster, wherein the crosslinker is an admixture of metal-based compound, wherein the metal-based compound is a trivalent metal-based compound, polyethylene glycol or derivatives of polyethylene glycol, wherein the polyethylene glycol or derivatives of polyethylene glycol have molecular weight ranging in between 200 Da to 20 000 Da, hydroxide salts, wherein the hydroxide salt is selected from the group consisting of potassium hydroxide, sodium hydroxide, ammonium hydroxide or mixtures thereof, and water, where the latex formulation includes polyethylene oxide, wherein the polyethylene oxide having molecular weight ranging in between 20 kDa to 1000 kDa.

US2017218142A1 relates to synthetic elastomeric articles, such as gloves, comprising the cured product of a synthetic latex composition, the synthetic latex composition comprising a synthetic carboxylated polymer and a cross-linking composition, the cross-linking composition comprising an aqueous solution of a negatively charged multivalent metal complex ion having a pH of at least 9.0. This prior art also provided the compositions for forming the articles, and methods for making the articles, based on the use of the described cross-linking composition. The articles, compositions and methods may contain an aqueous solution of a multimetal oxide of the multivalent metal, a hydroxide of the multivalent metal, or a salt of the multivalent metal, such as sodium aluminate, in an amount of less than 0.3 phr.

US413052A disclosed a neoprene composition containing a latex of a copolymer of chloroprene with an alpha, beta-ethylenically unsaturated carboxylic acid, such as methacrylic or acrylic acid, the polymerization being conducted in the presence of polyvinyl alcohol, and zinc oxide or zinc hydroxide which has been previously contacted with an alkali metal hydroxide are particularly well suited for use in contact adhesives.

The above prior arts disclose pre-treated synthetic latex prepared in solid film which has short shelf life and large particle size. Accordingly, it can be seen in the prior arts that there exists a need to have an improved method to provide a readily usable pre-treated synthetic latex emulsion.

### SUMMARY OF THE INVENTION

An objective of the present invention is to provide a pre-treated synthetic latex emulsion which could be used straight way without adding any curatives for the process of dipping both supported and un-supported applications.

It is an objective of the present invention to provide a method to reduce the process timing, improve product quality and consistency of end product properties.

It is further an objective of the present invention to provide a method to prolonging the shelf life of the pre-treated synthetic latex emulsion multiple times to the current industrial practices.

Also, it is an objective of the present invention to provide a method to reduce the usage of reactive chemicals involved in the process of cross-linking mechanism

Accordingly, these objectives may be achieved by following the teachings of the present invention. The present invention relates to a method for preparing a pre-treated synthetic latex emulsion, the method comprising the steps of, adding a synthetic latex into a tank, characterized by mixing a surfactant with the synthetic latex in the tank, adding alkaline material into a mixture of the synthetic latex added with the surfactant, adding a reactive metal ion into the mixture and continue mixing the mixture for at least two hours, wherein the reactive metal ion is obtained by heating a metal oxide or metal hydroxide with supply of alkaline material at 120 to 180° C.

### BRIEF DESCRIPTION OF THE ACCOMPANYING DRAWINGS

So that the manner in which the above-recited features of the present invention can be understood in detail, a more particular description of the invention, briefly summarised above, may have been referred by embodiments, some of which are illustrated in the appended drawings. It is to be noted, however, that the appended drawing illustrate only typical embodiments of this invention and are therefore not to be considered limiting of its scope, for the invention may admit to other equally effective embodiments.

These and other features, benefits, and advantages of the present invention will become apparent by reference to the following text figure, with like reference numbers referring to like structures across the views, wherein:

FIG. 1 is a flowchart illustrating a method (100) for preparing a pre-treated synthetic latex emulsion in accordance with an embodiment of the present invention.

FIG. 2 illustrating two sets of graphs showing the elongation in % and tensile strength in MPa for the set of experiments T1 to T8 of pre-treated latex at before aging of the latex in accordance with a preferred embodiment of present invention.

FIG. 3 illustrating two sets of graphs showing the elongation in % and tensile strength in MPa for the set of experiments T9 to T17 of pre-treated latex at real time aging of the latex in accordance with a preferred embodiment of present invention.

FIG. 4 illustrating two sets of graphs showing the elongation in % and tensile strength in MPa for the set of experiments T19, T20, T26 and T27 of pre-treated latex which was subjected to aging at 70° C. in accordance with a preferred embodiment of present invention.

FIG. 5 illustrating two sets of graphs showing the elongation in % and tensile strength in MPa for the set of experiments T21 to T25 and T28 of pre-treated latex which was subjected to aging at 90° C. in accordance with a preferred embodiment of present invention.

### DETAILED DESCRIPTION OF THE PREFERRED EMBODIMENTS

While the present invention is described herein by way of example using embodiments and illustrative drawings, those skilled in the art will recognise that the invention is not limited to the embodiments of drawing or drawings described, and are not intended to represent the scale of the various components. Further, some components that may form a part of the invention may not be illustrated in certain figures, for ease of illustration, and such omissions do not limit the embodiments outlined in any way. It should be understood that the drawings and detailed description thereto are not intended to limit the invention to the particular form disclosed, but on the contrary, the invention is to cover all modifications, equivalents, and alternatives falling within the scope of the present invention as defined by the appended claim. As used throughout this description, the word “may” is used in a permissive sense (i.e. meaning having the potential to), rather than the mandatory sense, (i.e. meaning must).

Further, the words “a” or “an” mean “at least one” and the word “plurality” means “one or more” unless otherwise mentioned. Furthermore, the terminology and phraseology used herein is solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes. Any discussion of documents, acts, materials, devices, articles and the like is included in the specification solely for the purpose of providing a context for the present invention. It is not suggested or represented that any or all of these matters form part of the prior art base or were common general knowledge in the field relevant to the present invention.

In this disclosure, whenever a composition or an element or a group of elements is preceded with the transitional phrase “comprising”, it is understood that we also contemplate the same composition, element or group of elements with transitional phrases “consisting of”, “consisting”, “selected from the group of consisting of, “including”, or “is” preceding the recitation of the composition, element or group of elements and vice versa.

The present invention is described hereinafter by various embodiments with reference to the accompanying drawing, wherein reference numerals used in the accompanying drawing correspond to the like elements throughout the description. This invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. These values and ranges are to be treated as examples only and are not intended to limit the scope of the claims. In addition, several materials are identified as suitable for various facets of the implementations. These materials are to be treated as exemplary and are not intended to limit the scope of the invention.

With reference to the drawings, the invention will now be described in more detail.

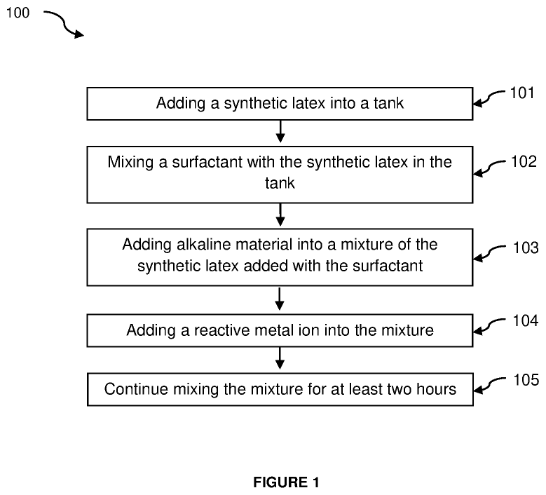

FIG. 1 is a flowchart illustrating a method (100) for preparing a pre-treated synthetic latex emulsion in accordance with an embodiment of the present invention.

The present invention relates to a method (100) for preparing a pre-treated synthetic latex emulsion, the method is comprising the steps of, adding a synthetic latex into a tank (101), characterized by mixing a surfactant with the synthetic latex in the tank (102), adding alkaline material into a mixture of the synthetic latex added with the surfactant (103), adding a reactive metal ion into the mixture (104) and continue mixing the mixture for at least two hours (105), wherein the reactive metal ion is obtained by heating a metal oxide or metal hydroxide with supply of alkaline material at 120 to 180° C.

In accordance with an embodiment of the present invention, the higher temperature, 120 to 180° C. is required to obtain the required ionization energy so that the metal oxide or metal hydroxide will come out of the stable state of oxide or hydroxide to ready react-able state. The reactive material may be separately solubilized using excessive alkali and heat in a non-corrosive high grade stainless steel vessel. The resultant solubilized material could be further diluted and stored in plastic drums it is preferably to keep the pH of the solution around 13 pH to avoid any re-deposition of curative materials and this will help to maintain the reactive oxidative state of the elements concerned. At excessive supply of alkaline earth metal more specifically potassium (K) and heat approximately around 120 to 180° C. is maintained however water is needed in the beginning stage to initiate the dissociation. Once the dissociation is effected it is cooled down with excess water.

In accordance with an embodiment of the present invention, the synthetic latex is carboxylated acrylonitrile butadiene rubber.

In accordance with an embodiment of the present invention, the synthetic latex is selected from a polymer with carboxylic acid monomer such as acrylonitrile, butadiene and carboxylic acid or styrene, butadiene and carboxylic acid and a combination thereof. The selected polymer with carboxylic acid monomer comprising a carboxylic acid content of 2 to 10%.

In accordance with an embodiment of the present invention, the synthetic latex is selected from a polymer without carboxylic acid monomer such as acrylic, styrene acrylic, polychloroprene, polyisoprene, polyurethane, polyacrylates, polyvinyl chloride, polyvinyl acetate and a combination thereof.

In accordance with an embodiment of the present invention, the synthetic latex is strained using a strainer comprising single or multiple filtering media capable of removing particulates before adding into the tank, preferably coarse mesh of 20 to 40 mesh. While pumping the latex from or to the tank, the latex has to pass through suitable strainers to remove skin formed by evaporation, grit and micro-floc (micro-lump/coagulam) formed due to contamination. In accordance with an embodiment of the present invention, the raw latex is pumped into the tank, preferably from the bottom of the tank to avoid excess bubbling and frothing or the latex to be poured in such a way that it slides through the wall directly or the pipe attached to the inside wall of the tank. The excess bubbles could be stabilized by the addition of defoamer at 0.001%.

The defoamer comprises of vegetable origin or mineral based or silicone based depending on the end application of the latex.

In accordance with an embodiment of the present invention, the surfactant mixed with the synthetic latex in the tank at 30 to 100 rpm for 1 to 4 hours.

In accordance with an embodiment of the present invention, the maximum amount of the surfactant is at 7.0 phr. The addition of surfactant is to achieve longer storage shelf life.

In accordance with an embodiment of the present invention, the surfactant diluted at 1:3 to 1:15.

In accordance with an embodiment of the present invention, the surfactant comprises of anionic surfactant, non-ionic surfactants or a combination thereof.

In accordance with an embodiment of the present invention, the anionic surfactant is selected from sulfonic acid salts, alcohol ether sulphates, alcohol sulphates, alkyl benzene sulfonates, phosphoric acid esters, alkyl carboxylates, alkyl ethoxylated carboxylates, alkyl sulfates, alkyl ethoxylated sulfates, olefin sulfonates and isethionates.

In accordance with an embodiment of the present invention, the non-ionic surfactant is selected from alkyl ethoxylates, alcohol ethoxylates, fatty acid alkanolamides, alkylamine oxides, alkyl polyglucosides, polyglycerol alkyl ethers, glucosyl dialkyl ethers, polyethylene glycol, alkyl polyethylene glycol ether, sorbitan esters, polysorbates and alkyl, fluorinated and silicone based polyethylene oxide, oligomeric surfactants and poly alkylene oxide block copolymers.

In accordance with an embodiment of the present invention, the maximum amount of the reactive metal ion is at 0.25 phr.

In accordance with an embodiment of the present invention, the metal oxide or metal hydroxide whereby the metal is selected from Zinc, Aluminium or Copper. Even though the Aluminium identified for use in dipping industry and the usage was not recommended due to its neuro toxic effect on human however ionizing of Aluminium is relatively easier and require relatively less ionization energy compared to Zinc. In this invention priority is given to the use of Zinc, Aluminium is used where there is no direct contact to human.

In accordance with an embodiment of the present invention, the maximum amount of the alkaline material is at 5.0 phr. In accordance with an embodiment of the present invention, the alkaline material is potassium hydroxide. The most preferred metal is potassium among the Group I alkaline metals however other metals of similar chemical characteristics could be used depending on the end use of the article.

In accordance with an embodiment of the present invention, the potassium hydroxide is diluted at 2 to 5% of potassium hydroxide, preferably in de-ionized water.

In accordance with an embodiment of the present invention, the steps further comprising addition of ammonium hydroxide diluted at the range of 1:2 to 1:20 to boost the pH during adding of the reactive metal ion.

In accordance with an embodiment of the present invention, the steps further comprising the step of adding covalent bonding agent after addition of the reactive metal ion.

In accordance with an embodiment of the present invention, the covalent bonding agent is in a solubilized form and/or micronized form.

In accordance with an embodiment of the present invention, the maximum amount of the covalent bonding agent is at 0.25 phr.

In accordance with an embodiment of the present invention, the covalent bonding agent is selected from sulphur and/or sulphur donor.

In accordance with an embodiment of the present invention, the reactive metal ion is an activated metal of higher oxidation state consisting of Zinc or combination with other higher oxidation metal selected from Aluminium and or other metals selected from transitional or post transitional group wherein said metal is activated by heating at a temperature of 120° C. to 180° C. in alkaline condition.

In accordance with an embodiment of the present invention, the activated metal of higher oxidation state consisting of Zinc and other like material in the form of solid or in a heterogeneous or homogeneous solution with water.

The synthetic latex is preferably pumped into the tank by using pneumatic diaphragm pump to avoid any mechanical shock to the latex emulsion. Prior to the pumping, the tank is preferably to be thoroughly cleaned to eliminate any visible and invisible contamination. The invisible contamination can be checked by pH visual appearance and smell, and total colony forming units present in the water after rinse of the tank. It has to be in line with the cleaning water property. Hard tools shall be avoided while cleaning which may damage the inner wall of the tank, by creating dents and deep scratches which will harbour dirt and bio-contaminations (bacteria) during the subsequent mixing operations carried out in the mixing tank.

The tank used in the present invention is preferably but not limited to stainless steel of grade (SS 306, SS 347, SS 321, SS 316), epoxy modified phenolic coated steel, vinyl ester coated steel and Glass fiber reinforced plastics (FRP).

Since the latex is being handled by filtration, chemical addition and dilution with water the possibilities of biological contamination addition of biocide may be required in case of prolonged storage at tune of 0.01 to 0.15%. The preferred biocide is 1,2-Benzisothiazolin-3-one commercially available as ROCIMA BT 2S by ROHM and HAAS or other types approved by USFDA for use in rubber article that contact with food.

Hereinafter, examples of the present invention will be provided for more detailed explanation. It will be understood that the examples described below are not intended to limit the scope of the present invention.

### EXAMPLES

TABLE 1
The following set of experiments is designed for
making of pre-treated latex as described above.

| | Initial Experiment | | | | | | | |
|---|---|---|---|---|---|---|---|---|
| | T1 | T2 | T3 | T4 | T5 | T6 | T7 | T8 |
| Real time aging | 80 | 43 | 22, 26 | 35 | 41 | 32 | 32 | 30 |
| (days) | | | | | | | | |
| Experiment ref. | T9 | T10 | T11, T12 | T13 | T14 | T15 | T16 | T17 |
| 50° C. - Aging | — | 31 | — | — | — | — | — | — |
| (Days) | | | | | | | | |
| Experiment ref. | — | T18 | — | — | — | — | — | — |
| 70° C. - Aging | 30, 90 | — | 23, 90 | — | — | — | — | — |
| Days | | | | | | | | |
| Experiment ref. | T19, T27 | — | T20, T26 | — | — | — | — | — |
| 90° C. - Aging | 17, 40 | 18 | 11 | — | — | — | — | — |
| Days | (55 d@50 c.) | (55 d@50 c.) | | | | | | |
| Experiment ref. | T21, T28 | T22 | T23-T25 | — | — | — | — | — |

TABLE 2
The following are the experiment matrix used in the experiments.
Experiment Matrix

| | 1 | 2 | 3 | 4 | 5 | 6 | 7 | 8 |
|---|---|---|---|---|---|---|---|---|
| Zn²⁺O²⁻ | 0.01 | 0.01 | 0.05 | 0.01 | — | 0.01 | 0.02 | 0.03 |
| Al₂³⁺O₃²⁻ | 0.05 | 0.08 | — | — | 0.03 | 0.05 | 0.06 | 0.02 |
| Sₓ²⁻ | — | 0.01 | — | — | — | — | — | 0.01 |
| ZDBC | — | 0.01 | — | — | — | — | — | — |
| TiO₂ | — | 2.5 | — | — | — | — | — | — |
| KOH | 0.45 | 0.5 | 0.7 | 0.3 | 0.5 | 2.2 | 2.5 | 2.8 |
| SDBS | 0.3 | 0.4 | 0.3 | 0.3 | 0.3 | 0.3 | 0.5 | 0.5 |
| XL-100 | 0.1 | 0.3 | 0.2 | 0.3 | 0.3 | 0.2 | 0.3 | 0.5 |
| SLES | — | — | — | — | — | 0.5 | 0.5 | 0.5 |
| PEG4000 | — | — | — | — | 0.3 | 0.5 | 0.5 | 1 |
| NBR | 100 | 100 | 100 | 100 | 100 | 90 | 85 | 86 |
| CR | | | | | | 10 | 10 | |
| PI | | | | | | | | 14 |
| NR | | | | | | | 5 | |
| Total rubber | 100 | 100 | 100 | 100 | 100 | 100 | 100 | 100 |
| CaCO₃ | | | | | | 5 | 5 | |

Notes:
The numbers indicated are in phr (parts per hundred parts of rubber)
ZDBC Zinc Dibutyl Dithio Carbomate
TiO₂ Titanium oxide
S Sulphur
KOH Potassium hydroxide
SDBS Sodium dodecyl benzene sulphonate
XL-100 Lutensol XL 100 - Alkyl polyehtlyene glycol ethers of BASF
SLES Sodium Lauryl Ether Sulphate
PEG 4000 Poly Ethylene Glycol
NBR Nitrile Butadiene Rubber
CR Chloroprene rubber
PI Polyisoprene rubber
NR Natural rubber
CaCO₃ Calcium Carbonate

### Description of the Experiments

Total of 8 different set of experiments were planned with the following experimental parameters, in the preparation of Pre-Treated (PT) synthetic polymeric latex.

### Experiment 1 (T1)

The combination of both 2+ and 3+ oxidative state metals were tried at the tune of 0.01 and 0.05 phr.

### Experiment 2 (T2)

The combination of both 2+ and 3+ oxidative state metals were tried at the tune of 0.01 and 0.08 phr, along with covalent bonding agent Sulphur and Sulphur donor and Titanium dioxide as blocking and coloring agent.

### Experiment 3 (T3)

Only 2+ oxidative state metal, at the tune of 0.05 phr was used, in the preparation of PT latex.

### Experiment 4 (T4)

Only 2+ oxidative state metal, at the tune of 0.01 was used, in the preparation of PT latex. Even though the experiment 3 is of similar nature this experiment 4 was planned with low level of (1/5 of the previous experiment) and study the effect thereof.

### Experiment 5 (T5)

Only 3+ oxidative state metal was tried at the tune of 0.03 phr.

### Experiment 6 (T6)

Combination two synthetic polymeric latexes were blended in this trial. Also with the combination of both 2+(0.01 phr) and 3+(0.05 phr) oxidative state metals were tried, in addition inorganic additive was also tried.

### Experiment 7 (T7)

Combination two synthetic polymeric latexes and natural rubber latex were blended in this trial. Also with the combination of both 2+(0.02 phr) and 3+(0.06 phr) oxidative state metals were tried, in addition inorganic additive was also tried.

### Experiment 8 (T8)

Combination two synthetic polymeric latexes (different from the combination of Experiment 6) were blended in this trial. Also with the combination of both 2+(0.03 phr) and 3+(0.02 phr) oxidative state metals were tried.

### Experiment 9-17 (T9-T17)

The above set of PT latexes prepared as per Experiments T1 to T8 were tested after a real time aging ranging from 22 days to 80 days stored in ambient temperature about 25-30° C. The varying real times with respect to total of 9 experiments were indicated in the above Table in the respective columns pertaining to the experiments concerned.

### Experiment 18 (T18)

The PT latex made as per the conditions of Experiment 2 was subjected to accelerated aging at 50° C. for a period of 31 days. In order to study the properties and PT latex stability.

### Experiment 19 (T19)

The PT latex made as per the conditions of Experiment 1 was subjected to accelerated aging at 70° C. for a period of 19 days. In order to study the properties and PT latex stability.

### Experiment 20 (T20)

The PT latex made as per the conditions of Experiment 3 is subjected to accelerated aging at 70° C. for a period of 23 days. In order to study the properties and PT latex stability at elevated temperature.

### Experiment 21 (T21)

In this experiment multiple aging conditions were tried. The PT latex made as per the conditions of Experiment 1 was subjected to initial accelerated aging at 50° C. for 55 days and the same aged latex was continued for rigorous accelerated aging at 90° C. for a period of 17 days. In order to study the properties and PT latex stability in an elevated multiple aging conditions.

### Experiment 22 (T22)

In this experiment multiple aging conditions were tried. The PT latex made as per the conditions of Experiment 2 was subjected to initial accelerated aging at 50° C. for 55 days and the same aged latex was continued for rigorous accelerated aging at 90° C. for a period of 18 days. In order to study the properties and PT latex stability in an elevated multiple aging conditions.

### Experiment 23 (T23)

The PT latex made as per the conditions of Experiment 3 is subjected to accelerated aging at 90° C. for a period of 11 days. In order to study the properties and PT latex stability at elevated temperature.

### Experiment 24 (T24)

The PT latex made as per the conditions of Experiment 3 is subjected to accelerated aging at 90° C. for a period of 11 days. In addition to the PT latex additional synthetic latexes viz., polychloroprene and nitrile butadiene latexes were added. In order to study the properties of multiple combination at compounding at end user side and PT latex stability at elevated temperature.

### Experiment 25 (T25)

The PT latex made as per the conditions of Experiment 3 is subjected to accelerated aging at 90° C. for a period of 11 days. In addition to the PT latex, substantial amount of additional additives like organic and inorganic materials were added. In order to study the properties after adding substantial amount of additives at compounding at end user side and PT latex stability at elevated temperature.

### Experiment 26 (T26)

The PT latex made as per the conditions of Experiment 3 is subjected to accelerated aging at 70° C. for a period of 90 days. In order to study the properties and PT latex stability at elevated temperature.

### Experiment 27 (T27)

The PT latex made as per the conditions of Experiment 1 is subjected to accelerated aging at 70° C. for a period of 90 days. In order to study the properties and PT latex stability at elevated temperature.

### Experiment 28 (T28)

In this experiment multiple aging conditions were tried. The PT latex made as per the conditions of Experiment 1 was subjected to initial accelerated aging at 50° C. for 55 days and the same aged latex was continued for rigorous accelerated aging at 90° C. for a period of 40 days. In order to study the properties and PT latex stability in an elevated multiple aging conditions.

### Results and Discussions

### Topic 1

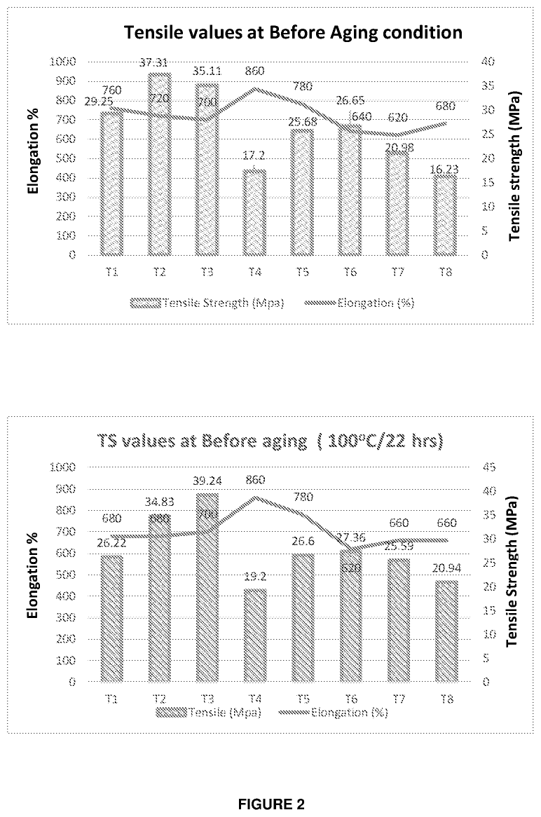

All the 8 experiments were tested, once the compound is made, by making a film in similar conditions using ASTM D 412 test methods for both before aging and after aging condition (100° C./22 hrs) and the results are compared in graphical form as depicted in FIGS. 2 to 5.

### Discussion on Topic 1

If go by accelerated aging results at 100° C./22 hrs T3 fares well with the highest tensile value of 39.24 MPa. This indicates the film is formed very well with relatively higher crosslinking density. This T3 uses single metallic curatives of oxidative state 2 that is Zn²⁺. If go by before aging condition T2 fares well with the tensile value of 37.31 which contains highest multiple metal combination and covalent bonding agents like sulphur and sulphur donors which is understandable. T4 has the lowest metallic curative of 0.01 and obviously end up with low tensile values both in unaged and aged conditions.

The last three items T6, T7 & T8 shows lower physical properties since they contain multiple set of polymeric material where the first 5 (T1-T5) sets contains single polymer. This indicates nitrile polymer is superior in strength under the PT latex conditions followed.

The highest elongation was from T4 which contains lowest curatives which is obvious, since the number of crosslinks are less and hence more flexible rather than the tightly bound structure which will obviously obstruct the movement between the layers which is the characteristics of the basic elastomer material.

The lowest elongation was recorded in T6 and T7 where they contain inorganic additives.

FIG. 2 illustrating two sets of graphs showing the elongation in % and tensile strength in MPa for the set of experiments T1 to T8 of pre-treated latex at before aging of the latex in accordance with a preferred embodiment of the present invention. In a preferred embodiment of the present invention, the top graph depicts the properties of the film formed at before aging condition and the bottom graph depicts the properties of the same film after subjecting to accelerated aging conditions of 100° C. for 22 hours.

### Topic 2

Topic 2 is selected to address the real time aging characteristics of the PT latex. 1.0 Totally 9 experiments are done each one to each type and one additional test in Experiment 3. Various level of real time period were considered starting from 22 days up to 80 days, they were chosen randomly to study the behaviour of PT latex upon regular storage conditions.

### Discussion on Topic 2

In the before aging test all the values are above 20 MPa and in the after aging condition all the values are above 25 MPa.

In the before aging condition of the test Experiment 6 (T15) fared well with the highest tensile strength. In the after aging condition Experiment 2 (T10) and Experiment 5 (T14) both fared well. Experiment 7 (T16) ended up with the lowest tensile in both the tests, could be due to the combination of natural rubber with other two synthetic materials viz. nitrile and polychloroprene and also contain inorganic additives.

The PT latex compound as per Experiment 2, containing metal oxide ions of oxidative state 2 and 3, and sulphur and accelerator was initially subjected to an accelerated aging at 50° C. and then diluted to the tune of 28%-30% total solid content and subjected to further accelerated aging condition at 90° C. for a period of 100 days. At the end of the 100 days the latex was still found to be in stable state without coagulum formation however mild color change and mild foul smell noticed which will not affect the film formation for the intended end use.

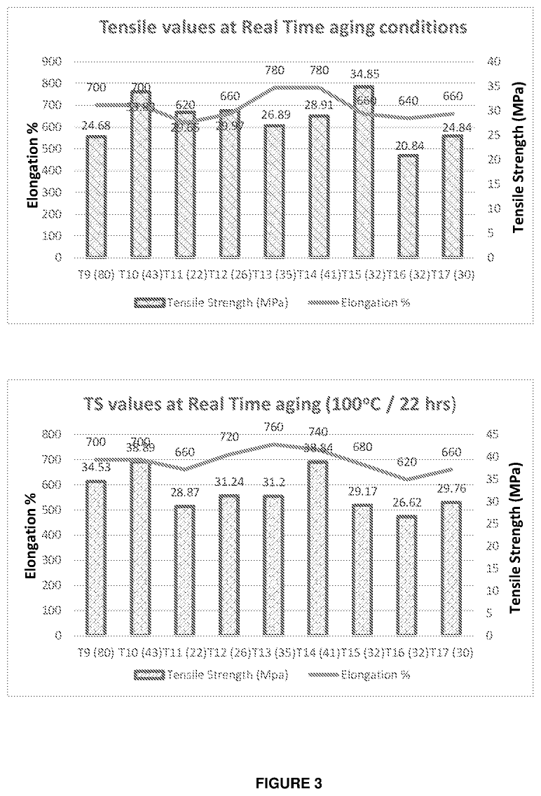

FIG. 3 illustrating two sets of graphs showing the elongation in % and tensile strength in MPa for the set of experiments T9 to T17 of pre-treated latex at real time aging of the latex in accordance with a preferred embodiment of the present invention. In accordance with a preferred embodiment of the present invention, the top graph depicts the properties of the film formed at real time aging condition and the bottom graph depicts the properties of the same film after subjecting to accelerated aging conditions of 100° C. for 22 hours.

### Topic 3

Topic 3 is selected to address the accelerated aging characteristics of the PT latex. Totally 4 experiments are done at accelerated aging temperature of 70° C. varying from 23 days to 90 days. They were chosen randomly to study the behaviour of PT latex upon regular storage conditions.

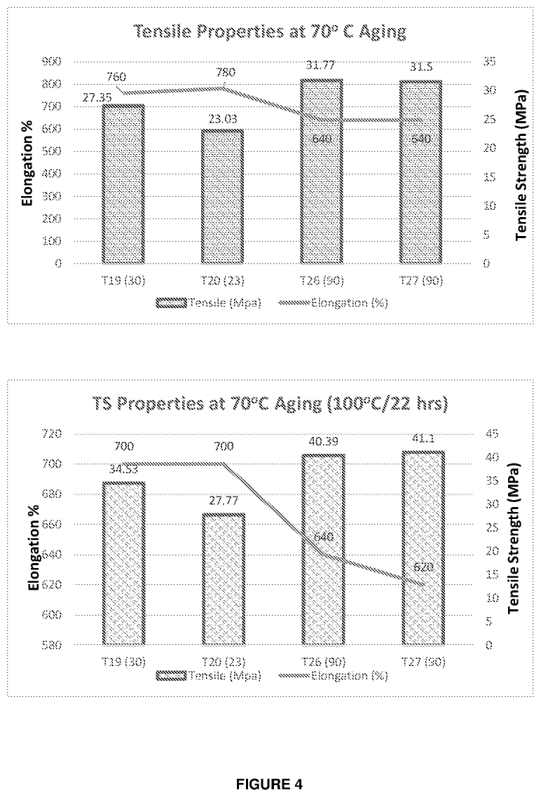

FIG. 4 illustrating two sets of graphs showing the elongation in % and tensile strength in MPa for the set of experiments T19, T20, T26 and T27 of pre-treated latex which was subjected to aging at 70° C. in accordance with a preferred embodiment of the present invention. In accordance with a preferred embodiment of the present invention, the top graph depicts the properties of the film formed by the pre-treated latex subjected to 70° C. condition and the bottom graph depicts the properties of the same film after subjecting to accelerated aging conditions of 100° C. for 22 hours.

### Discussion on Topic 3

In in unaged condition T26 (Experiment 3 is the origin) marginally fares well, T27 (Experiment 1 is the origin) is also very close. Even though the PT latex is discoloured at this condition and had foul smell the properties are excellent. In the simulated 100° C./22 hrs aging as per the standard, T27 fares well and T26 is also very close in performance. Surprising both are aged for 90 days.

One of the main observations is that at high temperature accelerated aging condition of 70° C. the prolonged time increases the strength and lowers the elasticity but still meets the intended purpose.

### Topic 4

Topic 4 is selected to address the accelerated aging characteristics of the PT latex. Totally 6 experiments are done at accelerated aging temperature of 90° C. varying from 11 days to 40 days. They were chosen randomly to study the behaviour of PT latex upon regular storage conditions.

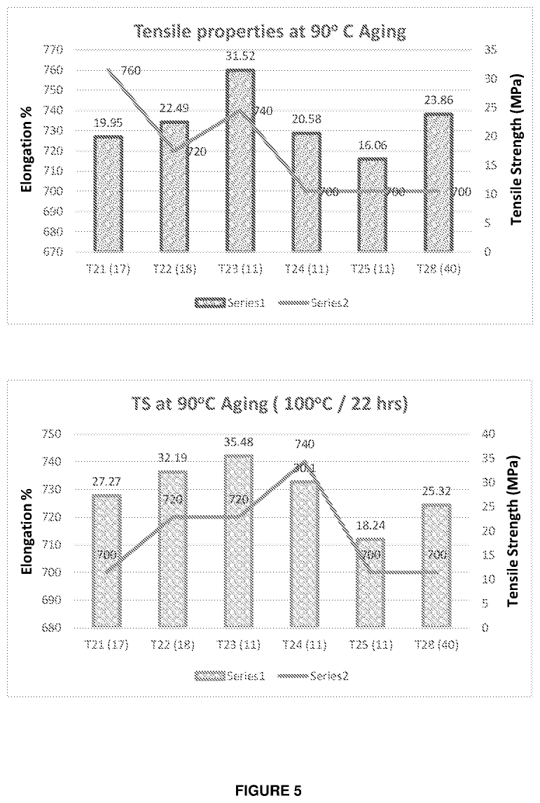

FIG. 5 illustrating two sets of graphs showing the elongation in % and tensile strength in MPa for the set of experiments T21 to T25 and T28 of pre-treated latex which was subjected to aging at 90° C. in accordance with a preferred embodiment of the present invention. In accordance with a preferred embodiment of the present invention, the top graph depicts the properties of the film formed by the PT latex subjected to 90° C. condition and the bottom graph depicts the properties of the same film after subjecting to accelerated aging conditions of 100° C. for 22 hours.

### Discussion on Topic 4

Since the time at which the various trials were done varies largely we could not compared all across in the same plane. However 40 days trial could be taken as worst case scenario. Since 90° C. is the nearer zone to the boiling point of water. At this point the entropy of the individual molecules will be at higher level at such a high level of entropy the reactive molecules especially the higher oxidative state with free electron will be at its peak point of reaction with higher molecular oscillation. The excessive alkali and surfactant prevents such reaction or at least controls in such a way that the entire latex is not gelled up and preventing film formation. There could be some residual reactions however it was found that there is no micro flocking due to extensive reaction which will adversely affect the PT latex in the film formation. There was no visual indication that such micro flocking or micro coagulation occurred and when we filtered the latex with 200 mesh there is no such coagulum observed. If we see the safe storage condition recommended by the latex manufacturer, they recommend below 40° C. compared to this the PT latex of this invention even with curatives could be stored at higher temperature. The only change to the regular latex is that the PT latex has some foul smell related to emission of sulphur related compounds and nitrogenous compounds, however this does not affect the film formation or the property of the film adversely.

In this exercise of 90° C. accelerated aging three different experiments were involved viz., Experiment 1, 2 & 3. This covers the use of single oxidative metal, multiple oxidative metals and multiple oxidative metals and in combination with covalent bonding aids and other additives.

The most aggressive condition is that T28, where the PT latex was subjected to 90° C. condition for a period of 40 days. The total polymeric system and the curing systems all subjected to severe thermal stress which in turn influences the severe movement of ions and molecules which will lead to internal reactions and severance of longer molecular chains to break up and results in lowering of physical properties. With all that unwanted side effect the resultant film passes to meet the standard's requirement.

The pre-treated synthetic latex emulsion produced via the present invention is applicable to industries which uses synthetic polymeric emulsion as raw material in the making of various dipped articles, adhesives and coatings. The main application aims at dipped industry involved in the making of skin protection equipment and related items but not limited to various types of gloves viz., food contact gloves, dental gloves, general examination gloves used in medical field, surgical gloves, industrial gloves, laboratory gloves, finger cots and other medical devices like catheters, protective covers, tubes and both female and male condoms and the like.

Synthetic polymer film formed by the pre-treated synthetic latex emulsion have more uniformity and more homogeneous texture with less film defects like pin holes and lumps and other visual defects like uneven flow lines. The strength of the film formed by the present invention possesses higher mechanical strength and more elasticity.

Various modifications to these embodiments are apparent to those skilled in the art from the description and the accompanying drawings. The principles associated with the various embodiments described herein may be applied to other embodiments. Therefore, the description is not intended to be limited to the embodiments shown along with the accompanying drawings but is to be providing the broadest scope of consistent with the principles and the novel and inventive features disclosed or suggested herein. Accordingly, the invention is anticipated to hold on to all other such alternatives, modifications, and variations that fall within the scope of the present invention and appended claim.

1. A method (100) for preparing a pre-treated synthetic latex emulsion, the method comprising the steps of:
adding a synthetic latex into a tank (101);
characterized by;
mixing a surfactant with the synthetic latex in the tank (102);
adding alkaline material into a mixture of the synthetic latex added with the surfactant (103);
adding a reactive metal ion into the mixture (104); and
continue mixing the mixture for at least two hours (105);
wherein the reactive metal ion is obtained by heating a metal oxide or metal hydroxide with supply of alkaline material at 120 to 180° C.

2. The method (100) as claimed in claim 1, wherein the synthetic latex is carboxylated acrylonitrile butadiene rubber.

3. The method (100) as claimed in claim 1, wherein the synthetic latex is selected from a polymer with carboxylic acid monomer such as acrylonitrile, butadiene and carboxylic acid or styrene, butadiene and carboxylic acid and a combination thereof.

4. The method (100) as claimed in claim 1, wherein the synthetic latex is selected from a polymer without carboxylic acid monomer such as acrylic, styrene acrylic, polychloroprene, polyisoprene, polyurethane, polyacrylates, polyvinyl chloride, polyvinyl acetate and a combination thereof.

5. The method (100) as claimed in claim 1, wherein the synthetic latex is strained using a strainer comprising single or multiple filtering media capable of removing particulates before adding into the tank.

6. The method (100) as claimed in claim 1, wherein the surfactant mixed with the synthetic latex in the tank at 30 to 100 rpm for 1 to 4 hours.

7. The method (100) as claimed in claim 1, wherein the maximum amount of the surfactant is at 7.0 phr.

8. The method (100) as claimed in claim 1, wherein the surfactant diluted at 1:3 to 1.15.

9. The method (100) as claimed in claim 1, wherein the surfactant comprises of anionic surfactant, non-ionic surfactants or a combination thereof.

10. The method (100) as claimed in claim 9, wherein the anionic surfactant is selected from sulfonic acid salts, alcohol ether sulphates, alcohol sulphates, alkyl benzene sulfonates, phosphoric acid esters, alkyl carboxylates, alkyl ethoxylated carboxylates, alkyl sulfates, alkyl ethoxylated sulfates, olefin sulfonates and isethionates.

11. The method (100) as claimed in claim 9, wherein the non-ionic surfactant is selected from alkyl ethoxylates, alcohol ethoxylates, fatty acid alkanolamides, alkylamine oxides, alkyl polyglucosides, polyglycerol alkyl ethers, glucosyl dialkyl ethers, polyethylene glycol, alkyl polyethylene glycol ether, sorbitan esters, polysorbates and alkyl, fluorinated and silicone based polyethylene oxide, oligomeric surfactants and poly alkylene oxide block copolymers.

12. The method (100) as claimed in claim 1, the maximum amount of the reactive metal ion is at 0.25 phr.

13. The method (100) as claimed in claim 1, wherein the metal oxide or metal hydroxide whereby the metal is selected from Zinc, Aluminium or Copper.

14. The method (100) as claimed in claim 1, wherein the maximum amount of the alkaline material is at 5.0 phr.

15. The method (100) as claimed in claim 1, wherein the alkaline material is potassium hydroxide.

16. The method (100) as claimed in claim 15, wherein the potassium hydroxide is diluted at 2 to 5% of potassium hydroxide.

17. The method (100) as claimed in claim 1, wherein the steps further comprising addition of ammonium hydroxide diluted at the range of 1:2 to 1:20 to boost the pH during adding of the reactive metal ion.

18. The method (100) as claimed in claim 1, wherein the steps further comprising
the step of adding covalent bonding agent after addition of the reactive metal ion.

19. The method (100) as claimed in claim 18, wherein the covalent bonding agent is in a solubilized form and/or micronized form.

20. The method (100) as claimed in claim 18, wherein the maximum amount of the covalent bonding agent is at 0.25 phr.

21. The method (100) as claimed in claim 18, wherein the covalent bonding agent is selected from sulphur and/or sulphur donor.

22. An additive for producing dipping articles characterized by: a reactive metal ion of claim 1; wherein said reactive metal ion is an activated metal of higher oxidation state consisting of Zinc or combination with other higher oxidation metal selected from Aluminum and/or other metals selected from transitional or post transitional group; wherein said metal is activated by heating at a temperature of 120° C. to 180° C. in alkaline condition for addition in a latex emulsion.

23. The additive for producing dipping articles as claimed in claim 22, wherein the activated metal of higher oxidation state consisting of Zinc and other like material in the form of solid or in a heterogeneous or homogeneous solution with water.
